(19) United States
(12) Patent Application Publication
(10) Pub. No.: US 2015/0051339 A1
(43) Pub. Date: Feb. 19, 2015

(54) METHOD FOR PROCESSING POLYMERS AND/OR POLYMER BLENDS FROM VIRGIN AND/OR RECYCLED MATERIALS VIA SOLID-STATE/MELT EXTRUSION

(71) Applicants: Northwestern University, Evanston, IL (US); Bucknell University, Lewisburg, PA (US)

(72) Inventors: Philip J. Brunner, South Milwaukee, WI (US); John M. Torkelson, Skokie, IL (US); Katsuyuki Wakabayashi, Lewisburg, PA (US)

(21) Appl. No.: 14/179,941

(22) Filed: Feb. 13, 2014

Related U.S. Application Data
(60) Provisional application No. 61/764,384, filed on Feb. 13, 2013.

(51) Int. Cl. B29B 7/48; C08J 3/20; B29B 7/82

(52) U.S. Cl. CPC B29B 7/482; B29B 7/82; C08J 3/203; B29K 2023/0683
USPC 524/585

(57) ABSTRACT

Polymer compositions and methods for their preparation, as can be considered through the use of a unitary solid-state/melt extrusion extruder apparatus.

This application claims priority benefit of application Ser. No. 61/764,384 filed Feb. 13, 2013, the entirety of which is incorporated herein by reference.

This invention was made with government support under grant number CMMI-0820993 awarded by the National Science Foundation. The government has certain rights in the invention.

### BACKGROUND OF THE INVENTION

Although twin-screw extrusion (TSE) has long been established as one of the most prominent techniques for processing homopolymers, copolymers, and polymer blends from virgin and/or recycled sources, the shear mixing in TSE is often not sufficiently rigorous to create a material with uniform and/or homogenous structure and properties. In addition, a long period of exposure to high temperature conditions in TSE can lead to thermal degradation of the materials. The solid-state shear pulverization (SSSP) technique has recently been proven as a novel technique to achieve better dispersion of heterogeneous nucleating agents in homopolymers and mixing of immiscible polymer blends relative to TSE. However, the SSSP technique yields a powder as output or extrudate, which for some intended applications is less desirable in terms of ease of handling and safety than the pelletized output from melt extrusion. Furthermore, even when SSSP is followed by melt extrusion, there would be energy inefficiencies from the separate instruments and a two-step process.

Therefore, a need exists for an extrusion approach that not only achieves good dispersion and mixing, but also facilitates production of a non-powder output, thereby eliminating safety concerns and/or problems with powder handling, in a single instrument. In addition, there is a need to develop an approach that is much more energy efficient than a two-step process of SSSP followed by melt extrusion.

### SUMMARY OF INVENTION

In light of the foregoing, it is an object of the present invention to provide one or more methods comprising a combination of solid-state shear pulverization and melt-state extrusion, together with a single self-contained apparatus useful in conjunction therewith. It would be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

It can be an object of the present invention to provide a methodology for production of non-powder polymer and polymer blend materials, thereby avoiding certain concerns relating to standard pulverization procedures.

It can also be an object of the present invention to provide such a methodology using a single, unitary apparatus, so as to avoid material transfer from one apparatus to another during production.

It can be another object of the present invention, alone or in conjunction with one or more of the preceding objectives, to provide an energy efficient process for producing polymer and/or polymer blend materials with enhanced physical and/or mechanical properties, as compared to prior art pulverization, alone, prior art melt extrusion, alone, or a combination of such processes via separate apparatuses.

Other objects, features, benefits and advantages of the present invention will be apparent from this summary and the following descriptions of certain embodiments, and will be readily apparent to those skilled in the art having knowledge of various polymer production techniques. Such objects, features, benefits and advantages will be apparent from the above as taken into conjunction with the accompanying examples, data, and all reasonable inferences to be drawn therefrom.

The invention can provide an approach for effectively dispersing and intimately mixing components in and/or with one or more types of polymers in a single twin-screw pulverization/extrusion instrument, thereby yielding products with desired morphology and superior physical properties. With respect to certain embodiments, a method of this invention can be referred to as Solid-State/Melt Extrusion (SSME), in that without limitation it can combine various principles of solid-state shear pulverization (SSSP) and twin-screw extrusion (TSE) into one continuous processing method in a single apparatus.

In part, this invention can be directed to a method of preparing or extruding a polymer and/or polymer blend using SSME. In one non-limiting embodiment, such a method can comprise feeding a polymer component selected from a homopolymer or copolymer, a mixture of two or more such polymers, or mixture of one or more such polymers with one or more additives into an extruder; solid-state shearing such a polymer component in an initial zone of the extruder; warming such a polymer component from a relatively low temperature to a warmer temperature in a transition zone of the extruder; mixing and heating such a polymer component above about the melting point of semi-crystalline polymers or about the glass transition temperature of amorphous polymers; and extruding such a polymer component.

Alternatively, this invention can be directed to a method of using a unitary solid-state shearing/melt-state extruder apparatus to prepare a polymer or polymer blend product. Such a method can comprise providing a unitary extruder apparatus comprising a solid-state shearing zone and melt-state extrusion zone; introducing one or more polymer components of the sort described above and illustrated elsewhere herein—such a polymer component selected from homopolymers, copolymers or a mixture of the two or more such homopolymers and/or copolymers and, optionally, one or more heterogeneous and/or additive components into such an apparatus to provide a mixture thereof; applying a mechanical energy through solid-state shearing of such a mixture in an initial zone of such an apparatus at a temperature sufficient to maintain such a polymer component in a solid state during shearing; warming such a mixture in a transition zone of such an apparatus, with warming at temperatures less than about the melting point or less than about the glass transition temperature of such a polymer component; and heating such a mixture in an end zone of such an apparatus at a temperature above about the melting point or above about the glass transition temperature of such a polymer component; with continued mixing of such a mixture. In certain embodiments, such a unitary apparatus can comprise a single- or multi-screw extruder configuration. In certain such embodiments, a twin-screw extruder can be employed.

In one non-limiting embodiment, an apparatus useful with a method of this invention can comprise (a) a feed zone for receiving a polymer or polymer mixture; (b) an initial zone for solid-state shearing the polymer or polymer mixture; (c) a transition zone for warming the polymer or polymer mixture from a relatively low temperature to warmer temperature; (d) a heating zone for heating the polymer or polymer mixture above the melting point of semi-crystalline polymers or glass transition temperature of amorphous polymers and for mixing the polymer or polymer mixture; and (e) a die for extruding the polymer or polymer mixture from the heating zone.

Regardless, without limitation, a polymer material useful in conjunction with the present invention can be a homopolymer, copolymer, or blends of multiple such polymers, whether from a virgin and/or recycled or scrap feedstock. In one non-limiting embodiment, a desired product can be a homopolymer or a copolymer in which naturally found heterogeneous nucleating agents are well-distributed, resulting in a polymer product with faster crystallization rate. In other such embodiments, a desired product can be a homopolymer or a copolymer in which an additive selected from but not limited to nucleating agents, colorants, plasticizers, flame retardants, UV and/or thermal stabilizers, biocides, antioxidants, lubricants and antistatic agents, and combinations of any such additive(s) and/or others of the sort described herein or would otherwise be known to one skilled in the art and made aware of this invention, are introduced and effectively distributed to yield a consistent solid product. In yet other embodiments, a resulting product can be a blend of two or more otherwise immiscible polymers that are intimately mixed and compatibilized.

A polymer component useful with a method of this invention can be selected from, but not limited to, polyesters, polyolefins, polyamides, epoxies, polycarbonates, polyacrylates, polyvinyls, polyethers, polyacrylonitriles, polyacetals, polysiloxanes, polyetherketones, elastomers, polyimides, polyurethanes, polystyrenes, copolymers thereof, combinations of such polymers, combinations of such copolymers and combinations of such polymers and copolymers. A heterogeneous additive component can be selected from, but is not limited to, waxes, salts, minerals and other such components of the type described elsewhere herein.

In accordance with this invention, SSME can combine advantages and remove limitations of currently existing homopolymer, copolymer, and/or polymer blend processing techniques. SSME can effectively disperse heterogeneous entities throughout the polymer matrix and intimately mix immiscible polymer blends in a continuous process while creating a molten extrudate that has had limited exposure to thermal degradation and can be readily post-processed. Such considerations can address hazards and/or issues associated with powder output and handling inherent to SSSP. Additionally, the excellent dispersion of heterogeneous entities in polymers and mixing of immiscible polymer blends can lead to enhanced physical properties in the resulting products. Furthermore, while SSSP followed by melt-extrusion introduces energy inefficiencies from two instruments, with SSME such inefficiencies are effectively reduced through use of a single unitary apparatus. Thus, an SSME process of this invention can yield relative energy savings.

### BRIEF DESCRIPTION OF THE DRAWINGS

FIG. 1. Instrumentation set-up and typical operating conditions for the proposed SSME processing method.

FIGS. 2A-D. Digital photograph images of compression molded films of PP/organic green pigment (99/1 w/w) molded (a) from a dry mixture as is, and molded after being processed via (b) EXT, (c) SSSP, and (d) SSME.

FIG. 3A-C. SEM images of cry-fractured specimens of PS/PE blends (90/10 w/w) processed via (a) EXT, (b) SSSP, and (c) SSME. The scale bar on the EXT image applies to all three images.

FIG. 4. Isothermal crystallization curves for PLA, (••••) as a neat pellet, and after being processed via (- - - -) EXT, ( - - - ) SSSP, and ( [symbol] ) SSME.

### DETAILED DESCRIPTION OF CERTAIN EMBODIMENTS

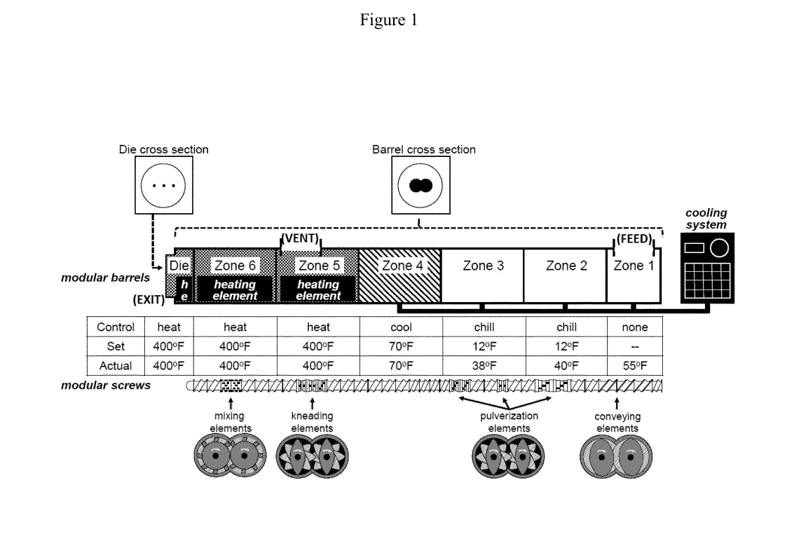

Certain non-limiting embodiments of this invention can be considered with reference to FIG. 1, a schematic illustration of an instrumentation set-up and operating conditions which can be used in conjunction with SSME methods of the present invention. Referring to FIG. 1, one such apparatus has a series of modular barrels, each barrel configured with at least one rotating screw therein. Each such screw configuration can comprise conveying, pulverizing, kneading and mixing elements, or a combination of such elements. An initial zone comprises at least one barrel and configured screw, together with a cooling system (e.g., without limitation, a recirculating chiller). A transition zone comprises at least one such barrel/screw, together with a heating element (e.g., without limitation, a cartridge heater). An end zone independently comprises at least one such barrel and screw configuration, together with a heating element. A terminal die component is coupled to an end zone for mixture extrusion. Such an apparatus can comprise a single- or multi-screw configuration, with individual screw elements ranging from 1 to about 45 in number per screw. Representative twin-screw configurations with bi-lobe elements are shown in FIG. 1. Optionally, for instance, tri-lobe or quad-lobe screw elements can also be used.

A typical twin-screw extruder has modular barrel zones with individual temperature settings. The SSME processing technique sets up the initial zone to a temperature that creates an environment for solid-state shearing of the homopolymer or copolymer or polymer mixture at a low temperature, typically below the melting point of semi-crystalline polymers or glass transition temperature of amorphous polymers. In FIG. 1, this is shown as Zones 1-3. The next zone is a transition zone with a higher temperature setting to serve as a buffer/transition area between the initial and subsequent zones. This is shown as Zone 4 in FIG. 1. The remaining zone or zones are set at a higher temperature, typically above the melting point of semi-crystalline polymers or glass transition temperature of amorphous polymers. This is shown as Zones 5 and 6 in FIG. 1.

The rotating screws of a typical extruder can also be modular. For example, for use with an SSME technique, the screw configuration where the pulverizing elements are located in the initial zones may be but are not necessarily chilled, melt mixing elements are concentrated in the end heated zones, and conveying zones are distributed to move the materials forward continuously in between the initial and end zones.

The SSME process can be described as successive cold (solid-state) pulverization and hot (melt-state) compounding in one continuous step in the same apparatus. The materials first enter the initial processing zone, where they remain in the solid-state as they are pulverized and mixed by high compressive and shear forces of SSSP processing. The materials then are conveyed from the initial zone to the transition zone, then to the heated zone, where they are kneaded, mixed, and extruded in the melt state. The extrudate is similar to that of commercial TSE, and thus can be further manipulated into desired shapes, which include but are not limited to strands, pellets or films. The barrel temperature settings and screw configuration in SSME provide sufficient solid-state pulverization action that promotes superior dispersion of heterogeneous additives that are naturally found or intentionally added in a homopolymer or copolymer and mixing of immiscible polymer blends, as well as melt-compounding and extrusion action to cause intimate mixing of the resulting homopolymer or copolymer or polymer mixture before being molded into a usable product. Various other apparatus components, configurations, parameters, settings and related considerations are as provided in co-pending application Ser. No. 13/654,154 filed Oct. 17, 2012—the entirety of which is incorporated herein by reference, such components, configurations, parameters, settings and related considerations as can be varied as would be understood by those skilled in the art made aware of this invention, and as may be utilized to provide a polymeric material suitable for desired end-use application.

The present invention, utilizing SSME, can be used for the commercial processing of polymers and/or production of polymer blends (current blends produced by an existing process or future blends that have not been commercialized yet) for dispersion of one or more heterogeneous entities (e.g. nucleating agents, pigments and the like) throughout a polymer matrix (or polymer component(s) heterogeneous therewith, at least partially immiscible therein and/or otherwise chemically or physically incompatible) for desired physical property enhancement. In addition, the extrudate is suitable for applications where industrial-scale mass production and immediate shaping/molding into end-use products is useful.

Without limitation, this invention can be applied to:
Structural modification to existing homopolymers, copolymers, and polymer blends for controlled and enhanced physical performance;
Formulation of new polymer blend materials from unconventional, immiscible components (virgin or recycled);
Processing and formulation of post-consumer recycled materials of homopolymers, copolymers, and polymer blends;
Production of pelletized materials of homopolymers, copolymers, and polymer blends made from virgin or recycled materials; and
Types of industries interested in the applications include packaging, automotive, electronics, consumer products, structural and building, sports equipment, and advanced materials.
   Advantages of the invention include but are not limited to the following:
It can achieve better dispersion of heterogeneous additives, such as pigments and nucleating agents, whether added to or naturally found in homopolymers/copolymers, compared to conventional melt extrusion techniques;
It can achieve more intimate mixing of immiscible polymer blends compared to conventional melt extrusion techniques;
It eliminates cumbersome powder handing that existing SSSP technique requires; and
It can be more energy and/or time efficient than two step SSSP/melt extrusion technique.

As relates to certain embodiments, commercial production of polymeric materials, whether derived from homopolymers, copolymers, polymer blends and/or polymer composites, oftentimes involves the inclusion of small-molecule additives such as antioxidants, UV and thermal stabilizers, processing aids, and colorants—as well as other additives of the sort discussed elsewhere herein. These additive materials are available in the form of particulates and pellets, small amounts of which should be well-mixed into the batch of polymer product in an efficient fashion prior to molding of the final product. Especially in the case of coloring thermoplastic polymers, dispersing organic pigment in the polymer matrix can be challenging because of the natural tendency of the pigment particles to agglomerate.

With reference to Example 4, below, to illustrate various embodiments, comparisons were made between dispersions of an organic pigment in polypropylene (PP) homopolymer under conventional melt extrusion (EXT) conditions, solid-state shear pulverization (SSSP) conditions, and a solid-state/melt extrusion process (SSME) of this invention.

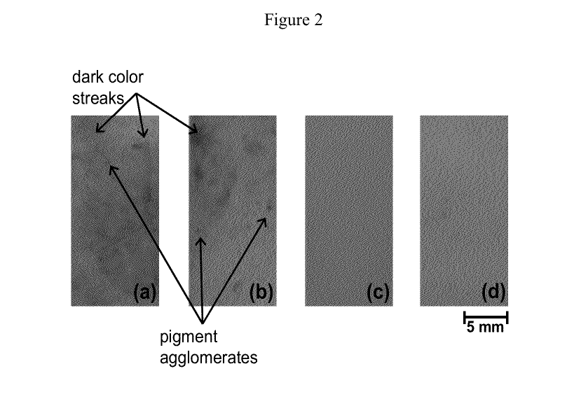

FIG. 2 is a side-by-side comparison of four molded specimens of PP colored with green organic pigment, at 99/1 w/w ratio. The images were taken with a digital camera, using the same camera-to-object distance, aperture and shutter speed, with the specimens back-lit by a fluorescent light box. The control molded specimen, from a dry manual blend of the polymer and pigment, in FIG. 2(a), exhibits poor color uniformity; darker green color streaks are observed in various parts of the specimen. In addition, regularly distributed spots of dark green, as large as 1 mm in size, are observed. These spots are pigment particle agglomerates. Streaks and agglomerates are evidence of poor dispersion of the green pigment arising from simple dry blending and melt molding process.

The specimen that underwent EXT method prior to being molded, in FIG. 2(b), shows higher overall areas of uniform green color scheme compared to the control sample. However, upon closer inspection, there are still regularly distributed spots of darker green, in the form of particles with diameter on the order of 100 μm. These color inconsistencies suggest that agglomerates of the organic pigment are not sufficiently broken up by the relatively low shear in the melt mixing and melt molding processes.

The specimens that were processed via SSSP and SSME methods prior to being molded, as shown, respectively, in FIGS. 2(c) and (d), both exhibit uniform color throughout, with little to no irregularities. Even upon closer inspection, these specimens do not exhibit color streaks or spots. Both SSSP and SSME processes are capable of providing uniform mixing and achieving superior organic pigment dispersion compared to traditional extrusion processing techniques. High shear and compressive forces in the solid state led to physical breakup of the pigment agglomerates in the polymer matrix. Subsequent rigorous mixing, in the solid state (SSSP) or melt state (SSME) led to uniform distribution of the color pigment in the final product. In this example, the throughput of the SSME process was more than 20 times higher than that of SSSP, suggesting a higher potential for commercial scale-up. In addition, contrary to SSSP, the SSME process involved no powder product handling.

As relates to certain embodiments, polymer blends or mixtures of two or more homopolymers and/or copolymers are a class of materials of great industrial interest due to potential for achieving desired sets of physical properties from already existing feedstocks. Polymer blending can yield materials with new or synergistic properties, replace high-cost polymers by partially replacing with commodity polymers, and even contribute to waste reduction by utilizing recycled polymers as feedstocks. However, in almost all cases of polymer blends, the components are immiscible with each other because they are not thermodynamically compatible. Depending on the level of intimate mixing that can be achieved between blend components, a binary polymer blend usually develops a morphology in which minor component is dispersed within a matrix of the major component. Much of the research has focused on controlling the size of the dispersed minor phase, as it can strongly affect the physical properties of the blend.

One step towards producing polymer blends with a desired dispersed morphology (and in turn a desired enhancement in properties) is to ensure that the blending action leads to an initial product microstructure with fine, sub-micron dispersion of the minor phase. With reference to Example 5, below, illustrating various such embodiments, the fineness of dispersion was quantitatively compared between model polystyrene (PS)—polyethylene (PE) blend samples prepared via conventional melt extrusion (EXT), solid-state shear pulverization (SSSP), and a solid-state/melt extrusion (SSME) process of this invention.

The domain size of a dispersed phase is strongly influenced by the degree of phase separation between immiscible blend components as well as their viscosity ratio. However, it has been previously shown that the blend morphology does not change significantly over time in the steady-state portions of mixers and extruders. This is because an equilibrium balance is quickly established between domain breakup due to shear forces in the process and domain coalescence due to thermodynamic tendency to migrate and grow. The samples in this study were all taken from steady-state process outputs, and thus represent a series that reflects the fundamental differences in the process method only.

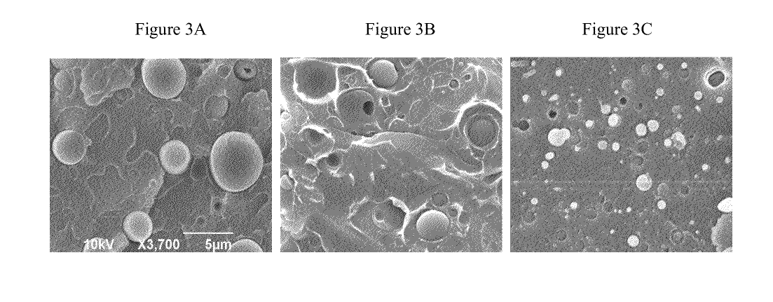

FIG. 3 compares the SEM images of the PS/PE blend processed via the three methods. The images were recorded with an identical SEM setting, at a magnification of 3700×. The specimen that underwent EXT method prior to being molded, in FIG. 3(a), shows relatively large, spherical minority phase domains, on the order of 4 μm in diameter. The specimen that was processed via the SSSP method prior to being compression molded and fractured, in FIG. 3(b), contains much smaller domain sizes, at the sub-micron level, though larger domains on the order of 2 μm in diameter also co-exist throughout. The morphology of the SSSP-processed specimen having a wide variance of domain sizes suggests that the pulverization method is effective at dispersing minority phases, but only in parts of the sample. The non-uniformity of the domain sizes may also be due to the coalescence of minority phase domains during the required post-processing molding step in preparing the SEM specimen. Lastly, the specimen that was processed via a present SSME method, in FIG. 3(c), shows more uniformly small domain sizes, approximately 1 μm and lower in diameter, that are well-dispersed in the matrix of majority component.

Table 1 summarizes the result of the quantitative analysis of the number-average domain diameter (Dₙ) of the dispersed phase. The average domain sizes in specimens prepared by SSSP and SSME are sub-micron, and at least 6-fold smaller than that processed by EXT. In addition, the variance of domain sizes in the SSME specimen is smaller than in the SSSP specimen, as previously depicted qualitatively in FIG. 3. In terms of desired blend morphology for consistent, enhanced physical properties in these materials, finer and more uniform distribution of minor phase domains found in the SSME specimen is ideal. Lastly, from a practical standpoint, the throughput of the SSME process was more than 3-fold higher than that of SSSP in this example. Furthermore, the SSME process involved no powder product handling, unlike the SSSP process.

TABLE 1
Process Conditions and Morphological Analysis
Results of the PS/PE Blend Samples

| | Through- | | Asso- | Calculated |
|---|---|---|---|---|
| Process | put | Specimen | ciated | Dₙ, avg ± one |
| Method | (g/hr) | Preparation | Figure | std. dev. (μm) |
| EXT | 1000 | Extrudate taken | FIG. 3(a) | 3.6 ± 1.4 |
| | | directly | | |
| SSSP | 290 | Output powder, | FIG. 3(b) | 0.56 ± 0.43 |
| | | melt-mixed and | | |
| | | compression molded | | |
| SSME | 1000 | Extrudate taken | FIG. 3(c) | 0.49 ± 0.23 |
| | | directly | | |

With respect to other embodiments of this invention, consider processing of poly(lactic acid) (PLA). As a biobased and biodegradable material, PLA has great potential—especially so for replacement of polypropylenes (PP) and polyethylene terephthaltates (PET) in the packaging industry. PLA can be obtained from renewable agricultural sources such as corn, sugar and milk byproducts, and is commercially available at a relatively low cost compared to other biodegradable polymers. Although PLA currently has some commercial success as biodegradable trash bags, utensils and water cups, it has been severely restricted in many other technological applications due to its low thermal stability, low toughness, and poor moisture barrier performance. These undesirable physical properties in PLA homopolymer are closely linked to the low crystallinity state found in as melt-processed specimens; PLA molecules are known to be exceptionally slow at arranging into crystals upon cooling from the melt.

As such, commercial processing like injection molding with PLA is impractical because the required cycle times are fast and does not allow crystallization to take place. There have been significant research efforts to overcome the grudgingly slow crystallization kinetics of PLA. One of the most common solutions is to add nucleating agents, but this methodology is only modestly effective in accelerating the crystallization rates, and not industrially scalable or economically feasible. Thus, there is a need for an alternative, commercially viable process to prepare highly crystalline and tough PLA homopolymers.

With reference to Example 6, below, to illustrate use of the present invention in conjunction with various homopolymers or copolymers, comparison was made between conventional melt extrusion (EXT), solid-state shear pulverization (SSSP), and a present solid-state/melt extrusion process (SSME) and corresponding effect on the crystallization rate and resulting mechanical properties, as well as the molecular structure, of a commercial PLA.

Commercial PLA pellets often contains residues of an initiator (catalyst) compound (up to 5% of the weight of the PLA resin), which is often used during the polymerization process to provide control over molecular weight. Suitable initiators include, for example, water, alcohols, polyhydroxy compounds, and polycarboxyl-containing compounds. These initiator residues are small heterogeneous compounds in the PLA matrix, thus can act as a nucleating agent for PLA when cooling from the melt. Therefore, when a processing method of PLA has sufficient mixing capabilities, it can effectively disperse the initiator residue in situ, and in turn facilitate the accelerated crystallization of the polymer.

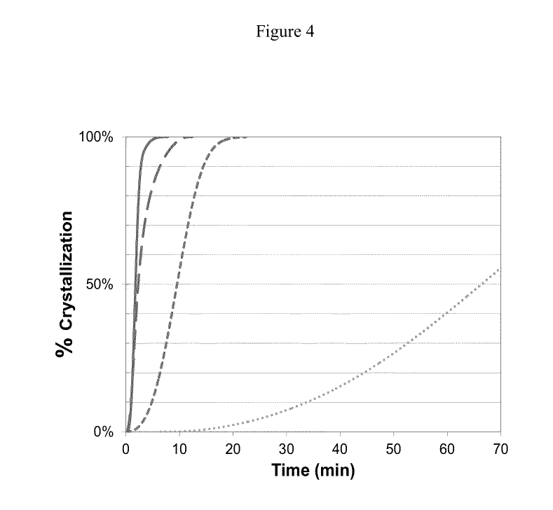

FIG. 4 compares the crystallization kinetics of the PLA homopolymer between the three processing techniques employed, by way of plotting the progress of crystallinity development at a constant temperature of 105° C. over time. The same measurement was conducted on an as-received, neat PLA pellet as a reference. The isothermal crystallization of as-received, neat PLA occurs the most slowly, as expected. A mixing process in the melt state improves the PLA crystallization kinetics, as the EXT isothermal curve falls significantly left of that for neat PLA. FIG. 4 shows that SSSP and SSME processing enhances the crystallization kinetics further, to an extent in which the polymer fully reaches its most crystalline state by 10 minutes of isothermal hold at 105° C. While both SSSP- and SSME-processed PLA start crystallizing out at about the same time, the growth of crystals occur slightly faster in the SSME-processed specimen than the SSSP-analog, resulting in a difference of approximately 5 minutes in terms of completion of crystalline formation.

One way to quantify the crystallization kinetics is crystallization half-time, t_{1/2}, which represents the time it takes for the specimen to reach 50% of its full crystalline formation. The t_{1/2} values for the four samples are listed in Table 2. The crystallization half-time of PLA that has been processed by some mixing method is reduced by at least 6-fold compared to as-received, neat analog. As observed in FIG. 4, SSSP and SSME are especially effective in enhancing the crystallization rate, having crystallization half-times of around 2 minutes. Rigorous mechanical sharing, compression, and mixing in the solid state facilitate a greater dispersion and distribution of nucleating agent catalyst particles.

TABLE 2
Processing Conditions and Physical Properties of the PLA Samples

| | | Isothermal | | | | |
|---|---|---|---|---|---|---|
| | | crystallization | Young's | Yield | | |
| Process | Throughput | half time @ | Modulus* | Strength* | Mₙ | M_{w} |
| Method | (g/hr) | 105° C. (min) | (GPa) | (MPa) | (g/mol) | (g/mol) |
| NONE | n/a | 66.4 | 2.1 ± 0.1 | 65 ± 2 | 56,000 | 95,000 |
| (Neat Pellets) | | | | | | |
| EXT | 310 | 9.6 | 2.0 ± 0.2 | 38 ± 5 | 44,000 | 82,000 |
| SSSP | 150 | 2.3 | 2.0 ± 0.1 | 64 ± 5 | 46,000 | 87,000 |
| SSME | 310 | 1.8 | 2.1 ± 0.1 | 56 ± 2 | 56,000 | 95,000 |

*The value after ± denotes the error within one standard deviation

In addition to the catalyst dispersion, processing of PLA can raise its crystallization rate for a different reason. Reduction of PLA molecular weight, by way of chain scission, can increase the mobility of the polymer chain and in turn increase its crystallization rate. Table 2 shows the results of the molecular weight characterization. PLA, being a bio-derived polyester, is prone to chemical degradation via hydrolysis reactions, and thus a simple melt process like EXT reduces its molecular weight (M_{w}) by 14%. However, highly rigorous solid-state processes like SSSP and SSME do not degrade PLA any further than EXT, keeping the level of PLA chain scission relatively low. In this example, the SSME specimen especially retained the original molecular weight of the as-received PLA, within error. From these results, it is reasonable to attribute the improvements in crystallization kinetics to the dispersion of initiator compounds as heterogeneous nucleation sites, not chain scission.

The fact that solid-state processing methods were able to keep polymer degradation to a low level led to mechanical property characterization. The results of static tensile testing are highlighted in Table 2. Comparison of Young's moduli across the series indicates that processing of PLA homopolymer in any of the methods retains the stiffness of the polymer. In terms of yield strength, on the other hand, the EXT method is not suitable at retaining the strength of the original PLA material. The deterioration of yield strength by 42% may be due to a combination of molecular weight reduction and the lack of sufficient crystal development. While SSSP processing retains the yield strength of the original material, the SSME method suffers a slight deterioration, by about 14%. Though the source of this reduction is not completely known, aside from the effects of slight chain scission, the reduction is not as large as EXT, and thus still in the practical application range of PLA. In addition, the processing throughput of SSME is more than double that of SSSP, as indicated in Table 2, which may be a factor in commercialization.

### EXAMPLES OF THE INVENTION

The following non-limiting examples and data illustrate various aspects and features relating to the methods of the present invention, including the preparation of various polymer materials and blends thereof, as are available through the methodologies described herein. In comparison with the prior art, the present methods provide results and data which are surprising, unexpected and contrary thereto. While the utility of this invention is illustrated through the use of several representative apparatus configurations, polymer materials and additives/agents processed therewith, it will be understood by those skilled in the art that comparable results are obtainable with various other apparatus configurations, polymers and additives incorporated therewith, as are commensurate with the scope of this invention.

### Example 1

This invention can be used in conjunction with various polymer materials such as those described in U.S. Pat. No. 6,797,216, the entirety of which is incorporated herein by reference. For instance, as would be understood by those skilled in the art and made aware of this invention, various amounts and/or proportions of post-consumer/post-industrial polymeric scrap material, virgin material, and blends thereof (e.g., binary, ternary, and quaternary, etc. blends of different polymers or a polymer from multiple sources), as illustrated in the '216 patent, can be processed in accordance with one or more embodiments of the present SSME methodology.

### Example 1a

Chopped polypropylene (PP), high-density polyethylene (HDPE) or low-density polyethylene (LDPE) scrap flakes, as described in the '216 patent (e.g., Examples 1-3 thereof), can be used in conjunction with the present methodology without undue experimentation.

### Example 1b

Blends of chopped HDPE, LDPE, and PP scrap material, as described in the '216 patent (e.g., Example 4 thereof), can be used in conjunction with the present methodology without undue experimentation.

### Example 1c

Blends of chopped HDPE and PP scrap flakes, as described in the '216 patent (e.g., Examples 5 and 6 thereof), can be used in conjunction with the present methodology without undue experimentation.

### Example 1d

Blends of chopped HDPE and LDPE scrap flakes, as described in the '216 patent (e.g., Example 7 thereof), can be used in conjunction with the present methodology without undue experimentation.

### Example 1e

Various other polymeric materials, including polyvinyl chloride (PVC), polystyrene (PS), polyethylene terephthalate (PET) and polycarbonate (PC) among others, and blends thereof, as described in the '216 patent (e.g., Table II thereof), can be used in conjunction with the present methodology without undue experimentation.

### Example 1f

Various blends of LDPE scrap flakes and virgin LDPE material, as described in the '216 patent (e.g., Table IV thereof), can be used in conjunction with the present methodology without undue experimentation.

### Example 1g

Blends of various virgin polymeric materials, as described in the '216 patent (e.g., Table V thereof), can be used in conjunction with the present methodology without undue experimentation.

### Example 1h

Blends of virgin PS and PE materials, as described in the '216 patent (e.g., Examples A-C thereof), can be used in conjunction with the present methodology without undue experimentation.

### Example 1i

With reference to the preceding examples, various feedstocks comprise a number of polymeric materials which are mutually thermodynamically incompatible, but when used in conjunction with the present methodology can be compatibilized and subsequently processed (e.g., injection molding, etc.) to provide materials with useful physical and mechanical properties.

### Example 2

Regardless of polymeric material, whether scrap, virgin or a combination of any such materials, methods of this invention can provide a shearing or pulverization effect at least partially sufficient to induce polymer scission and/or nucleation sites within or indigenous to such a polymer material; that is, such a method can be substantially absent either a nucleating agent or a filler component. The phrase “substantially absent” can be considered with reference to crystallization kinetics, mechanical properties, and/or corresponding polymer physical properties or morphologies of the sort described herein, in conjunction with this invention, such kinetics or properties as can be realized without such nucleating agent or filler components, in trace or in significant amounts or in amounts less than would otherwise be understood in the art as required to achieve such results.

Alternatively, the present invention can be utilized in conjunction with one or more nucleating agents known in the art. Mineral nucleating agents include chalk, clay, talc, silicates, and the like. Organic nucleating agents include but are not limited to salts of aliphatic or aromatic carboxylic acids and metallic salts of aromatic phosphate compounds and the like. Various other nucleating agents useful in conjunction with the present invention include those described in U.S. Pat. Nos. 7,569,630 and 7,879,933, each of which is incorporated herein by reference in its entirety.

### Example 3

Various colorants may be utilized in conjunction with the present invention. The term “colorant” when used herein denotes, for instance, any inorganic or organic pigment, organic dyestuff or carbon black, such a material as can be used in amounts up to about 1 wt %, about 3 wt %, about 5 wt %, about 10 wt %, about 20 wt %, about 30 wt %, about 40 wt %, about 50 wt % or more of the total colorant/polymeric resin mixture, and/or in amounts useful to achieve desired color characteristic. Such a colorant can be present at such or higher concentration in conjunction with a polymeric resin (e.g., as colorant pellets) in a master batch and “let-down” through subsequent processing, as would be understood by those skilled in the art. Those skilled in the art also will be aware of suitable inorganic pigments, organic pigments and dyestuffs useful as colorants. Such materials are described, for example, in Kirk-Othmer Encyclopedia of Chemical Technology, Third Edition, Vol. 6, pages 597-617, which is incorporated by reference herein; examples include, but are not limited to:

(1) inorganic types such as titanium dioxide, carbon black, iron oxide, zinc chromate, cadmium sulfides, chromium oxides, sodium aluminum silicate complexes, such as ultramarine pigments, metal flakes and the like; and

(2) organic types such as azo and diazo pigments, phthalocyanines, quinacridone pigments, perylene pigments, isoindolinone, anthraquinones, thioindigo, and the like.

Colorants can also be introduced as part of a scrap feedstock. For instance, blue-green or orange polypropylene bottle caps can be used alone or as part of a blend to provide a desired color component.

Various other conventional additives or mixtures thereof may also be included in the colorant polymeric mixture such as, for example and without limitation, lubricants, antistats, impact modifiers, antimicrobials, light stabilizers, filler/reinforcing materials (e.g., CaCO), heat stabilizers, release agents, rheological control agents such as clay, etc., and others of the sort described herein. Such colorants and/or additives can be incorporated in amounts known by those skilled in the art to achieve desired effect.

### Example 4

A dry, physical mixture of 99 wt % of PP pellets (Total Petrochemicals PP7525MZ, MFI=10 g/10 min at 230° C. and 2.16 kg as reported) and 1 wt % of green color concentrate powder (Accurate Color & Compounding) were prepared manually. No other additives, stabilizers, or processing aids were used. The PP/pigment mixture was processed in each of the following three distinct methods.

The conventional extrusion (EXT) method was performed using a Killion KLB-075 bench model extruder, with a diameter (D) of 19 mm and a length to diameter ratio (L/D) of 24. The average barrel zone temperature was 204° C. The throughput of 2200 g/hr was regulated by the screw setting, which was the manufacturer's original configuration for melt extrusion, as well as screw speed set at 70 rpm. The feed port was consistently full. The extrudate was air-cooled and pelletized.

The SSSP method was performed using a Berstorff ZE25 intermeshing, co-rotating twin-screw extruder with a length to diameter ratio (L/D) of 26.5, where its first section spanning L/D=19 has the barrel/screw diameter of 25 mm and remaining section of L/D=7.5 has the diameter of 23 mm. The screw setting designed for this study contained spiral conveying (for L/D=15) and bilobe kneading (for L/D=4) elements in the 25 mm-section, and spiral conveying (for L/D=0.5) and trilobe shearing (for L/D=7) elements in the 23 mm-section. The barrels are cooled by recirculating ethylene glycol/water mixture at −7° C. supplied by Budzar Industries WC-3 chiller. The screw speed was set at the standard 200 rpm, and the throughput of 100 g/hr was based on the feed rate controlled by the K-tron Soder S60 feeder. Powdered output was generated in the SSSP operation.

The SSME method was performed using a Berstorff ZE25-UTX intermeshing, co-rotating twin screw extruder with a diameter (D) of 25 mm and a length to diameter ratio (L/D) of 34. The barrel temperature setting was divided into three distinct zones along the length of the barrel. Zone 1, spanning the beginning length of L/D=16, was designed for solid-state pulverization; this portion of the barrel was continuously cooled at −12° C. by circulating ethylene glycol/water mixture from a Budzar Industries BWA-AC10 chiller. Subsequent Zone 2 (L/D=6) is an intermediate barrel section set at 21° C., where the materials transition from the solid- to melt-state. Finally, Zone 3 (L/D=12) is the melt extrusion zone in which the barrel was heated to 204° C. by standard cartridge-type electrical heaters. The screw setting designed for this study contained spiral conveying (for L/D=8.5) and bilobe kneading (for L/D=7.5) elements in Zone 1, all spiral conveying in Zone 2, and spiral conveying (for L/D=8.3) and bilobe shearing and mixing (for L/D=3.7) elements in Zone 3. The screws were set to rotate at 200 rpm, and PP/pigment mixture was metered by Brabender Technologic DS28-10 feeder upstream, resulting in the throughput of 2200 g/hr. The molten extrudate was water-cooled and pelletized.

The output material from each processing method was subjected to further melt processing, to mimic a typical commercial molding step (such as injection and rotational molding). In addition, the original dry manual blend of 99 wt % PP and 1 wt % pigment was also subjected to the identical melt processing to serve as a control. The material was melt-mixed in a batch cup-and-rotor mixer (Atlas Electronic Devices MiniMAX molder) for 2 min at 200° C. The melt-mixed material was then quickly cooled in a liquid nitrogen bath to freeze the morphology and subsequently compression molded into a film 0.8 mm thick using a hydraulic press (Carver Model C) set at 200° C. and 5 ton ram force. The molded polymer-pigment specimens were visually compared, as summarized above, to illustrate benefits available through SSME, in accordance with this invention.

### Example 5

The immiscible polymer blend system used in this study is composed of 90 wt % polystyrene (BASF Polystyrol 158K PS, MFI=3.0 g/10 min at 200° C. and 5.0 kg as reported, Mₙ, =106,000 g/mol, M_{w}=256,000 g/mol as determined by gel-permeation chromatography in-house) and 10 wt % polyethylene (Eastman Chemical Epolene C15, MFI=4200 g/10 min at 190° C. and 2.16 kg as reported). The two types of pellets were manually dry blended prior to being processed in each of the following three distinct methods.

The EXT method was performed using a Killion KLB-075 bench model extruder, with a diameter (D) of 19 mm and a length to diameter ratio (L/D) of 24. The average barrel zone temperature was 174° C. The throughput of 1000 g/hr was regulated by the screw setting which was the manufacturer's original configuration for melt extrusion, as well as screw speed set at 52 rpm. The feed port was consistently full. The extrudate was air-cooled and pelletized.

The SSSP method was performed using a Berstorff ZE25-UTX intermeshing, co-rotating twin screw extruder with a diameter (D) of 25 mm and a length to diameter ratio (L/D) of 34. The screw setting designed for this study contained spiral conveying (for L/D=20.7) and bilobe kneading (for L/D=13.3) elements, dispersed through the entire screw length. The barrels are cooled by recirculating ethylene glycol/water mixture at −12° C. supplied by Budzar Industries BWA-AC10 chiller. The screw speed was set at the standard 200 rpm, and the throughput of 290 g/hr was based on the feed rate controlled by the K-tron Soder S60 feeder. Powdered output was generated in the SSSP operation.

The SSME method was performed using a Berstorff ZE25-UTX intermeshing, co-rotating twin screw extruder with a diameter (D) of 25 mm and a length to diameter ratio (L/D) of 34. The barrel temperature setting was divided into three distinct zones along the length of the barrel. Zone 1, spanning the beginning length of L/D=16, was designed for solid-state pulverization; this portion of the barrel was continuously cooled at −12° C. by circulating ethylene glycol/water mixture from a Budzar Industries BWA-AC10 chiller. Subsequent Zone 2 (L/D=6) is an intermediate barrel section set at 21° C., where the materials transition from the solid- to melt-state. Finally, Zone 3 (L/D=12) is the melt extrusion zone in which the barrel was heated up to 177° C. by standard cartridge-type electrical heaters. The screw setting designed for this study contained spiral conveying (for L/D=9) and bilobe kneading (for L/D=7) elements in Zone 1, spiral conveying (for L/D=5) and bilobe kneading (for L/D=1) elements in Zone 2, and spiral conveying (for L/D=8.3) and bilobe shearing and mixing (for L/D=3.7) elements in Zone 3. The screws were set to rotate at 200 rpm, and the raw material mixture was metered by Brabender Technologie DS28-10 feeder upstream, resulting in the throughput of 1000 g/hr. The molten extrudate was water-cooled and pelletized.

Blend morphology characterization was conducted on the fractured surfaces of processed samples. In the case of EXT and SSME samples, a segment of the process extrudate was immersed in liquid nitrogen for 5 min and fractured. In the case of powdered SSSP output, the sample was first melt-mixed in a batch cup-and-rotor mixer (Atlas Electronic Devices MiniMAX molder) for 2 min at 200° C., and compression molded into a slab 0.8 mm thick using a hydraulic press (Carver Model C) set at 200° C. and 5 ton ram force, prior to being immersed in liquid nitrogen and fractured. The fractured surfaces of the prepared specimens were sputter-coated with gold using Denton Vacuum Desk IV, and observed using a JEOL JSM-6390LV scanning electron microscope (SEM), operating at an accelerating voltage of 10 kV. NIH ImageJ software was applied to the SEM images (FIG. 3) to calculate the number-average domain diameter of the dispersed phase (Dₙ), from automatically detected areas of the minor blend component phase. At least 200 particles were characterized from each sample. Comparative SEM analyses are summarized above, and illustrate benefits available through SSME, in accordance with this invention.

### Example 6

PLA homopolymer pellets (Cargill-Dow Polymers 2002D, 96/4 L/D, Mn-56,000 g/mol, Mw=95,000 g/mol as determined by gel permeation chromatography in house) were used without any additives or nucleating agents. PLA was processed in each of the following three distinct methods. In each case, the as-received PLA pellets were processed without any nucleating agent or other additives.

The EXT method was performed using a Killion KLB-075 bench model extruder, with a diameter (D) of 19 mm and a length to diameter ratio (LID) of 24. The average barrel zone temperature was 202° C. The throughput of 310 g/hr was regulated by the screw setting, which was the manufacturer's original configuration for melt extrusion, as well as screw speed set at 5 rpm. The feed port was consistently full. The extrudate was air-cooled and pelletized.

The SSSP method was performed using a Berstorff ZE25 intermeshing, co-rotating twin-screw extruder with a length to diameter ratio (L/D) of 26.5, where its first section spanning L/D=19 has the barrel/screw diameter of 25 mm and remaining section of L/D=7.5 has the diameter of 23 mm. The screw setting designed for this study contained spiral conveying (for L/D=16.5) and bilobe kneading (for L/D=2.5) elements in the 25 mm-section, and spiral conveying (for L/D=0.5) and trilobe shearing (for L/D=7) elements in the 23 mm-section. The barrels are cooled by recirculating ethylene glycol/water mixture at −7° C. supplied by Budzar Industries WC-3 chiller. The screw speed was set at the standard 200 rpm, and the throughput of 150 g/hr was based on the feed rate controlled by the K-tron Soder S60 feeder. Flake output was generated in the SSSP operation.

The SSME method was performed using a Berstorff ZE25-UTX intermeshing, co-rotating twin screw extruder with a diameter (D) of 25 mm and a length to diameter ratio (L/D) of 34. The barrel temperature setting was divided into three distinct zones along the length of the barrel. Zone 1, spanning the beginning length of L/D=16, was designed for solid-state pulverization; this portion of the barrel was continuously cooled at −12° C. by circulating ethylene glycol/water mixture from a Budzar Industries BWA-AC10 chiller. Subsequent Zone 2 (L/D=6) is an intermediate barrel section set at 21° C., where the materials transition from the solid- to melt-state. Finally, Zone 3 (L/D=12) is the melt extrusion zone in which the barrel was heated up to 204° C. by standard cartridge-type electrical heaters. The screw setting designed for this study contained spiral conveying (for L/D=8.5) and bilobe kneading (for L/D=7.5) elements in Zone 1, all spiral conveying elements in Zone 2, and spiral conveying (for L/D=9.7) and bilobe shearing and mixing (for L/D=2.3) elements in Zone 3. The screws were set to rotate at 200 rpm, and the raw material mixture was metered by Brabender Technologie DS28-10 feeder upstream, resulting in the throughput of 310 g/hr. The molten extrudate was air-cooled and pelletized.

Isothermal crystallization behavior of PLA samples (neat and processed via EXT, SSSP and SSME) was studied using differential scanning calorimetry (DSC). A TA Instruments Q1000 was used for EXT and SSME specimens, while a Mettler Toledo DSC822e was used for SSSP and SSSP-MM specimens. In both cases, an indium standard with a nitrogen purge was used to calibrate the instrument. The specimens were first heated from 40° C. to 200° C. at 10° C./min, and quickly cooled at 40° C./min to 105° C. and held for 90 min.

The Young's modulus (E) and tensile strength (σ_{y}) were measured via uniaxial tensile testing. Tensile test coupons were prepared from 0.5 mm thick compression molded sheets of each PLA sample, and tested in a Tinius Olsen H5K-S, following ASTM D1708.

Effects of processing on the PLA molecular weight were quantified using gel permeation chromatography (GPC, Waters Breeze). The GPC was calibrated with monodisperse polystyrene samples and tetrahydrofuran (THF) as solvent (HPLC grade, Aldrich) using a flow rate of 1.0 mL/min and a refractive index detector. In order to completely dissolve the PLA samples, PLA/THF mixtures were heated to ˜60° C. for 5 min.

Comparison of PLA crystallization kinetics, mechanical properties and other parameters are summarized, above, and illustrate benefits available with SSME, in accordance with this invention.

### Example 7

The following example illustrates another embodiment of this invention. In comparison with conventional polyolefins, ultrahigh molecular weight polyethylene (UHMWPE) possesses outstanding mechanical properties, including impact strength, making it highly desirable for applications ranging from body armor to implants. However, UHMWPE has an ultrahigh melt viscosity that renders common melt processes impractical for making products from UHMWPE. Attempts to overcome this problem by blending UHMWPE with polyethylene (PE) by conventional melt mixing have been unsuccessful because of the enormous viscosity mismatch and have led to a PE matrix with heterogeneous UHMWPE particles therein.

This invention can effectively and intimately mix UHMWPE/PE blends. As discussed above, in this process, the temperature is kept below the melting transition of PE, resulting in the breakdown and dispersion of UHMWPE particles in the PE matrix. Upon subsequent melt-processing at relatively low temperatures, these UHMWPE particles are at least partially immiscible with and remain suspended in the PE, but are small enough to act as a reinforcement material, thereby strengthening the blend. At higher melting temperatures, the PE and UHMWPE materials can be further melt-mixed to create a blend with enhanced properties. In this step, intimate mixing can be achieved because the process is not likely to be affected by viscosity mismatch.

Oscillatory shear rheology of blends containing, without limitation, up to about 20 wt % or more UHMWPE can show both an impact of the UHMWPE fraction in strongly modifying the low shear rate flow behavior and the very muted effect of that fraction on the high shear rate flow behavior. The latter effect indicates that such blends can be processed by melt extrusion and injection molding. Differential scanning calorimetry can support the presence of co-crystallization in these blends. Mechanical properties of these blends, including impact strength, can be enhanced.

Other component mixtures, varying by UHMWPE wt % (e.g., greater than about 0.1 wt %, as described above) can be used in conjunction with the methods described herein. Likewise, comparable mixtures of polypropylene (PP) and UHMWPP can be utilized to provide corresponding polymer blends.

We claim:

1. A method of using a unitary solid-state shearing/melt-state extruder apparatus to prepare a polymer blend product, said method comprising:
providing a unitary extruder apparatus comprising a solid-state shearing zone and a melt-state extrusion zone;
introducing a mixture of one or more polymer components and, optionally, one or more additive components to said apparatus;
solid-state shearing said mixture in an initial zone of said apparatus at a temperature sufficient to maintain a said polymer component in a solid state during shearing;
warming said mixture in a transition zone of said apparatus, said warming at a temperature less than about the melting point or less than about the glass transition temperature of a said polymer component; and
heating said mixture in an end zone of said apparatus at a temperature above about the melting point or above about the glass transition temperature of a said polymer component,
a said polymer component a polyethylene and a said additive component a colorant.
